(19) United States
(12) Patent Application Publication
(10) Pub. No.: US 2017/0205641 A1
(43) Pub. Date: Jul. 20, 2017

(54) Two Part Clamp with Spring-Loaded and Rigid Portions

(71) Applicant: Yossi Einhorn, Brooklyn, NY (US)

(72) Inventor: Yossi Einhorn, Brooklyn, NY (US)

(21) Appl. No.: 15/475,210

(22) Filed: Mar. 31, 2017

(51) Int. Cl. G02C 13/00

(52) U.S. Cl. CPC G02C 13/001

(57) ABSTRACT

A dual-part clamping device has a first side of which has a spring-loaded grasper with a larger surface area, and a smaller surface area rigidly connected pusher. First, the grasper is used to grasp onto an object, and a connector connecting the grasper to a clamping arm can or does move with respect to the clamping arm as grasper is pushed against a device connected to the other side of the clamp such as a second clamping arm. Then, by way of continued pushing the grasper against an object (clamping), the rigidly connected pusher then moves further toward the second clamping arm while the first arm remains stationary. In this manner, the second movement allows one to precisely push a connector through an object while the object is held in place by the grasper.

### FIELD OF THE DISCLOSED TECHNOLOGY

The disclosed technology relates generally to clamping devices, and more specifically, to one with two parts.

### BACKGROUND

Having to clamp together small pieces in order to connect them is very difficult on the hands. It involves repetitive motion and stress on the same parts of the skin, muscles, or tendons when doing so for tens or hundreds of pieces. This is a problem when producing electronics, especially those of a smaller size, eyeglasses, network cables, and precision machinery which requires precise positioning and clamping of parts together. A mechanism to accomplish this task with less strain on the hands is needed in the art.

### SUMMARY OF THE DISCLOSED TECHNOLOGY

Clamping devices of the embodiments of the disclosed technology have an upper plate connected to a grasper and a rigid pusher. The grasper is connected to a vertical connector which is movable through the upper plate while the rigid pusher is in a fixed position relative to the upper plate. A lower plate in a fixed position to a pedestal, such that clamping the upper plate and the lower plate together (moving the plates towards each other) causes the vertical connector to move through the upper plate. The grasper extends further from the upper plate than the rigid pusher, in some embodiments. The pedestal has, in some embodiments, at least one groove on an upper side thereof. At least one groove is adapted to receive a portion of a connector therein, such that a majority of the connector extends out from at least one groove. such as upwards toward the rigid pusher.

The grasper, in embodiments of the disclosed technology, has a pad at a bottom side thereof which is more flexible than the rigid pusher. It can also have a wider surface area and as such, is used for grasping a device, especially fragile devices, without causing damage (irreversible changes to the shape or structure). Further, “rigid” is defined as unable to change shape without causing damage. The grasper is spring-loaded in embodiments of the disclosed technology such that the spring applies resistive force to the clamping of the upper plate to the lower plate.

The clamping device can be used with eyeglasses such that the eyeglasses are aligned with a portal of the eyeglasses situated between the pedestal and the rigid pusher and glass (one of the actual lenses of the eyewear) is situated between the rigid pusher and the lower plate. The glass/lens is grasped by the grasper in a first instance, while the rigid pusher and the pedestal are spaced apart. In a second instance at a later time, the rigid pusher clamps the eyeglasses to the pedestal.

Said another embodiment, there are two clamping arms each actionable to clamp a respective first plate and second plate toward one another. A grasper is connected to the first plate by a vertical connector passing through the first plate. A spring, extending around the vertical connector and between the first plate and the grasper, applies force, keeping the grasper away from the first plate. Compression of the two clamping arms causes the spring to compress and the vertical connector to move through the first plate.

A rigid pusher connected to the first plate at a different location than the vertical connector is also used in embodiments, and extends perpendicularly from the rigid pusher. The grasper can be aligned such that when the two clamping arms are clamped together, the grasper contacts a support base which rises from a plane defined by the second plate. The grasper then hits the support base before the rigid pusher contacts a pedestal rising from the plane defined by the second plate when the two clamping arms are clamped together, some embodiments of the disclosed technology. The pedestal has two grooves perpendicular to each other on a side of said pedestal which contacts said rigid pusher when said two clamping arms are clamped together.

Clamping the two clamping arms together first causes the grasper and a device supported by the second plate to come in contact, then further clamping, in turn, causes the vertical connector to move through the first plate, and then in turn, still further clamping causes the rigid pusher to contact a device supported by the second plate in some embodiments.

Any device or step to a method described in this disclosure can comprise or consist of that which it is a part of, or the parts which make up the device or step. The term “and/or” is inclusive of the items which it joins linguistically and each item by itself. “Substantially” is defined as “at least 95% of the term being described” and any device or aspect of a device or method described herein can be read as “comprising” or “consisting” thereof.

### BRIEF DESCRIPTION OF THE DRAWINGS

FIG. 1 shows a perspective view of a first tool of embodiments of the disclosed technology.

FIG. 2 shows a perspective view of a second tool of embodiments of the disclosed technology.

FIG. 3 shows a side-elevation view of clamping elements of the disclosed technology.

FIG. 4 shows a side-elevation view of the clamping elements of

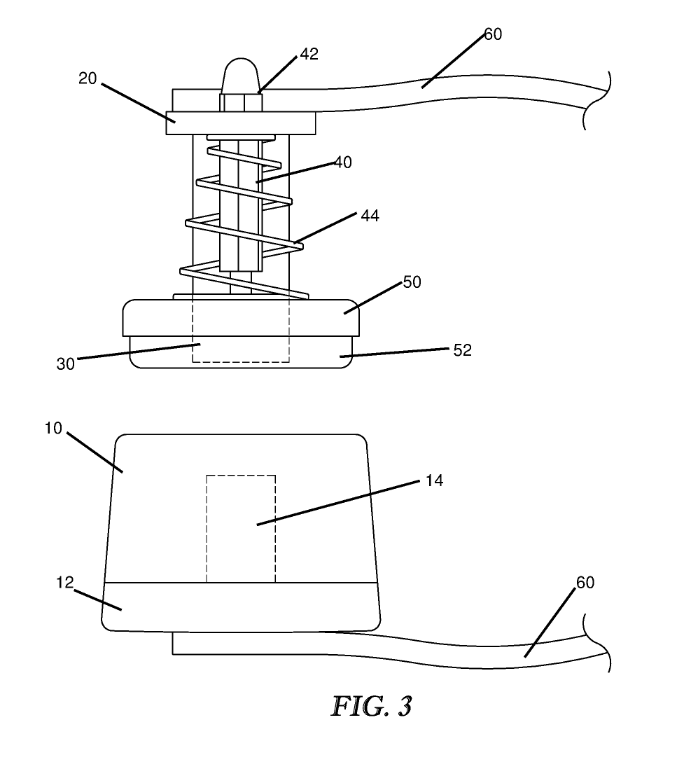

FIG. 3 clamping eyeglasses in an embodiment of the disclosed technology.

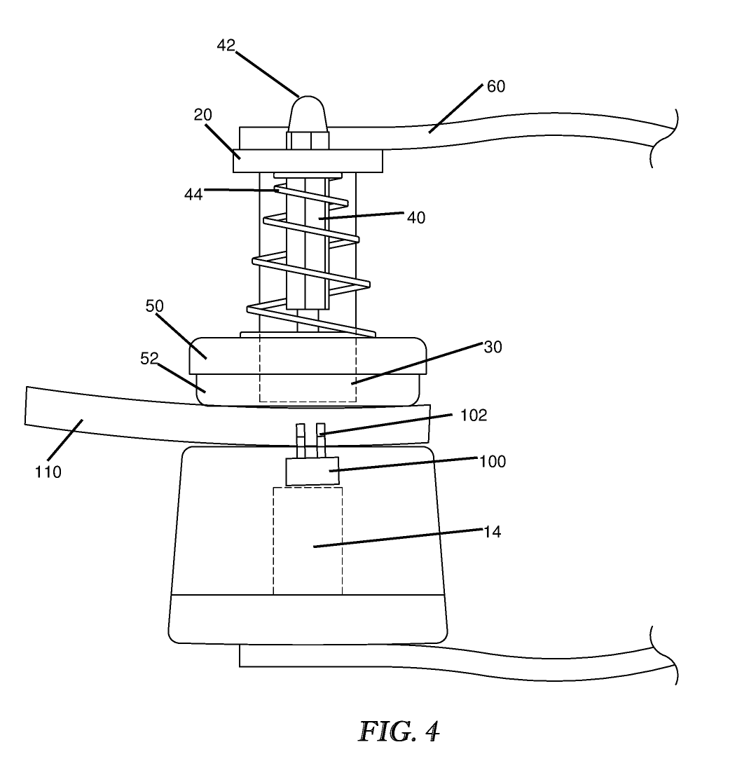

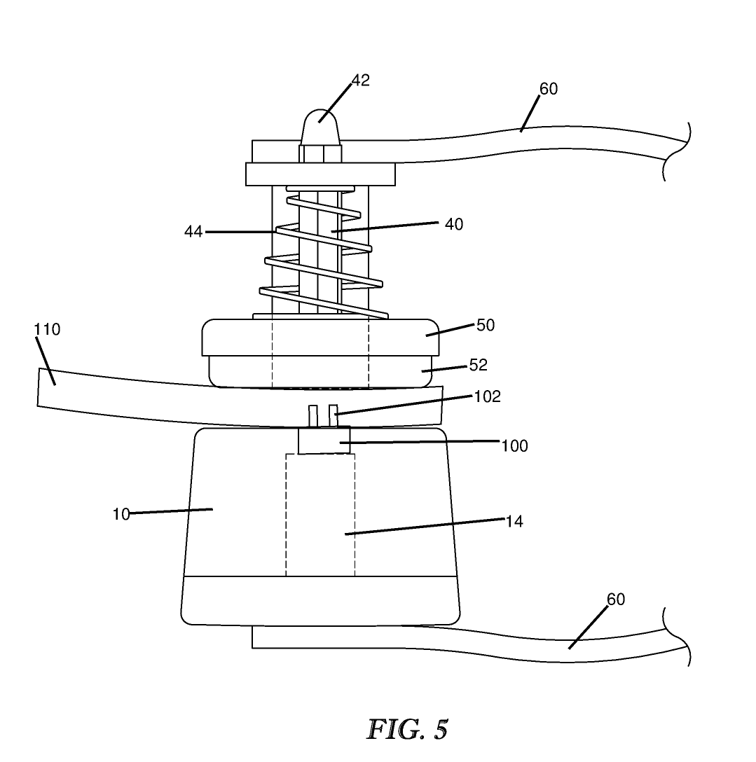

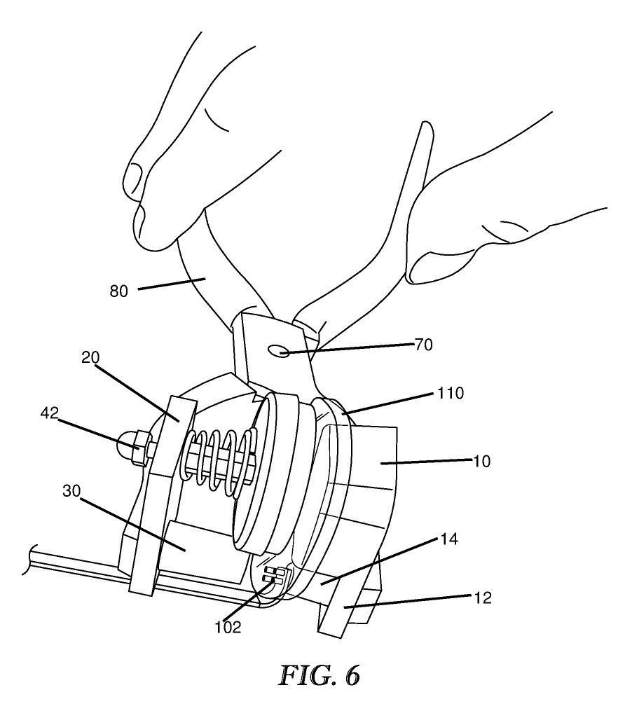

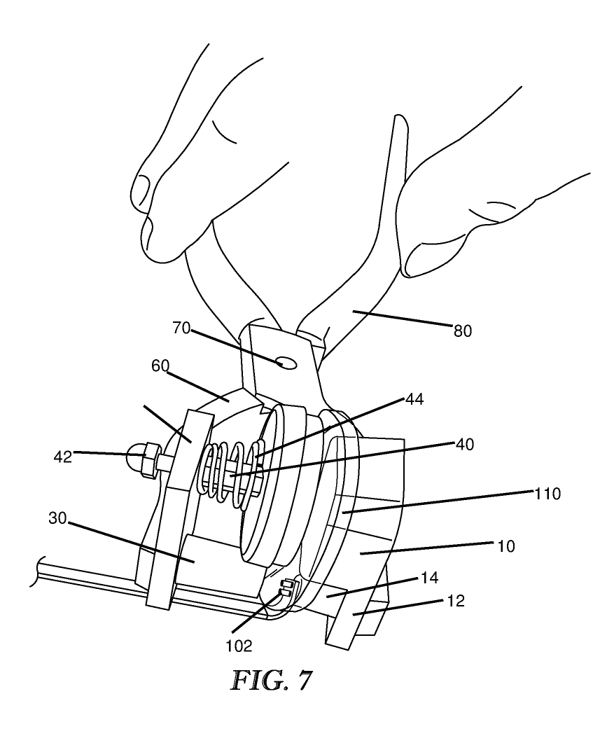

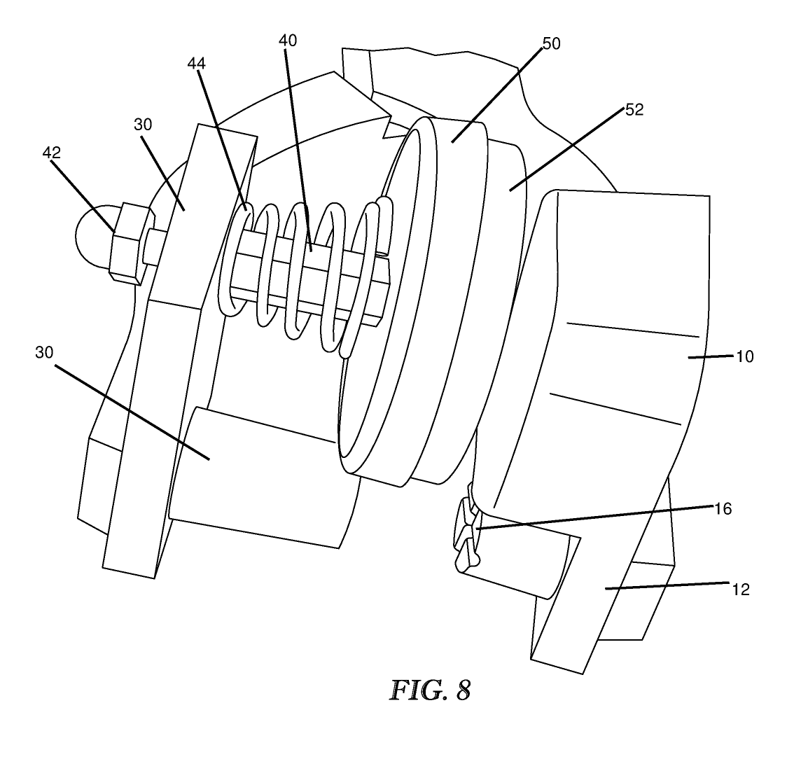

FIG. 5 shows a side elevation view of clamping elements of FIG. 4 clamping eyeglasses and a bushing holder in the disclosed technology.

FIG. 6 shows a perspective view of FIG. 4.

FIG. 7 shows a perspective view of FIG. 5.

FIG. 8 is a reverse-perspective view of the clamping elements of the disclosed technology.

### DETAILED DESCRIPTION OF EMBODIMENTS OF THE DISCLOSED TECHNOLOGY

A dual-part clamping device has a first side of which has a spring-loaded grasper with a larger surface area, and a smaller surface area rigidly connected pusher. First, the grasper is used to grasp onto an object, and a connector connecting the grasper to a clamping arm can or does move with respect to the clamping arm as grasper is pushed against a device connected to the other side of the clamp such as a second clamping arm. Then, by way of continued pushing the grasper against an object (clamping), the rigidly connected pusher then moves further toward the second clamping arm while the first arm remains stationary. In this manner, the second movement allows one to precisely push a connector through an object while the object is held in place by the grasper.

Embodiments of the disclosed technology will become more clear in view of the following description of the figures.

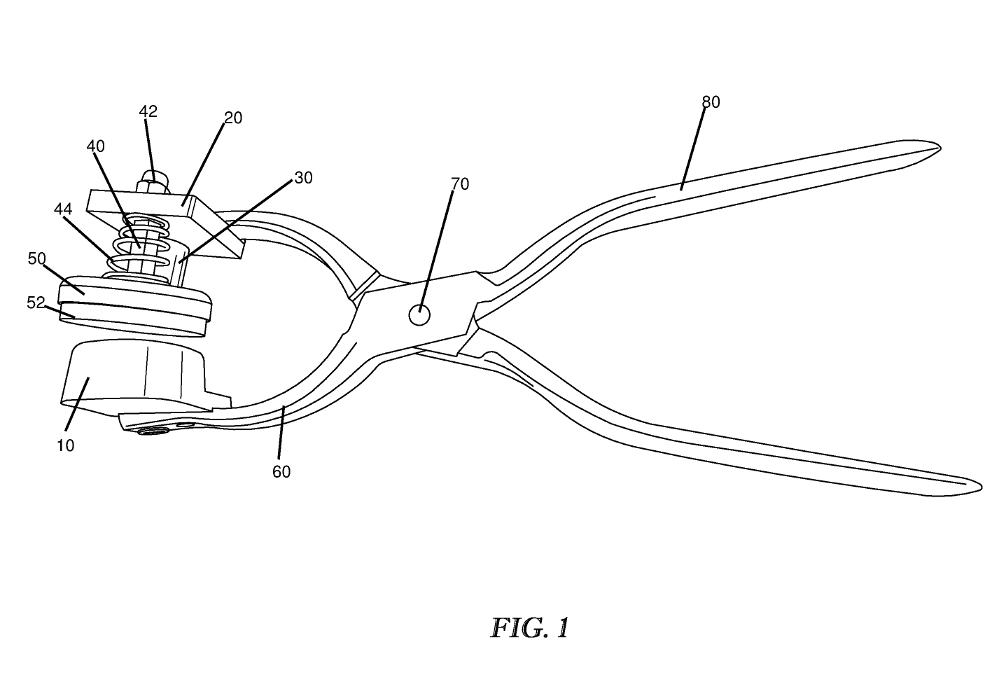

FIG. 1 shows a perspective view of a first tool of embodiments of the disclosed technology. In this clamping tool, there are outer clamping arms 80 which are pushed together around a fulcrum point 70 (such as a screw) which causes inner clamping arms 60 to move together. Between the clamping arms 60 are a variety of tools used to first grasp, and then press a bushing through the item being grasped. An upper plate 20 connects both a spring-loaded larger surface area grasper 50 and a rigid pusher 30 to the clamping arms 60. The grasper 50 can be padded with a pad 52. The pad 52 will have more flexibility and softness than the rigid pusher 30 in embodiments of the disclosed technology. The grasper 50 is connected in-line with a vertical connector 40 which passes through the upper plate 20, such that an upper most portion 42 of the vertical connector 40 extends out from a top side of the upper plate 20. For purposes of this disclosure, the “top side” is the side closed to the upper most portion 42 of the vertical connector 40, whereas the “bottom side” is on the opposite side thereof and is closest to the support base 10.

The vertical connector 40 is attached at a right angle to a top and generally or fully-flat side of the grasper 50. A spring 44, in embodiments of the disclosed technology, provides counter force against the movement of the grasper 50 upwards, such movement ocurring when the clamping arms 60 are moved together. Also connected to the upper plate is a rigid pusher 30 which extends less far from the upper plate 20 than the grasper 50 and/or the pad 52 when the clamp is in an open position (defined as “with space between the support base 10 and grasper 50, wherein the pad 52 is considered to be part of the grasper 50 if used in a particular embodiment”). Thus, the grasper 50 or pad 52, when the clamp moves from an open position to a closed position, makes contact with the support base 10 while the rigid pusher 30 moves in tandem with the grassper 50.

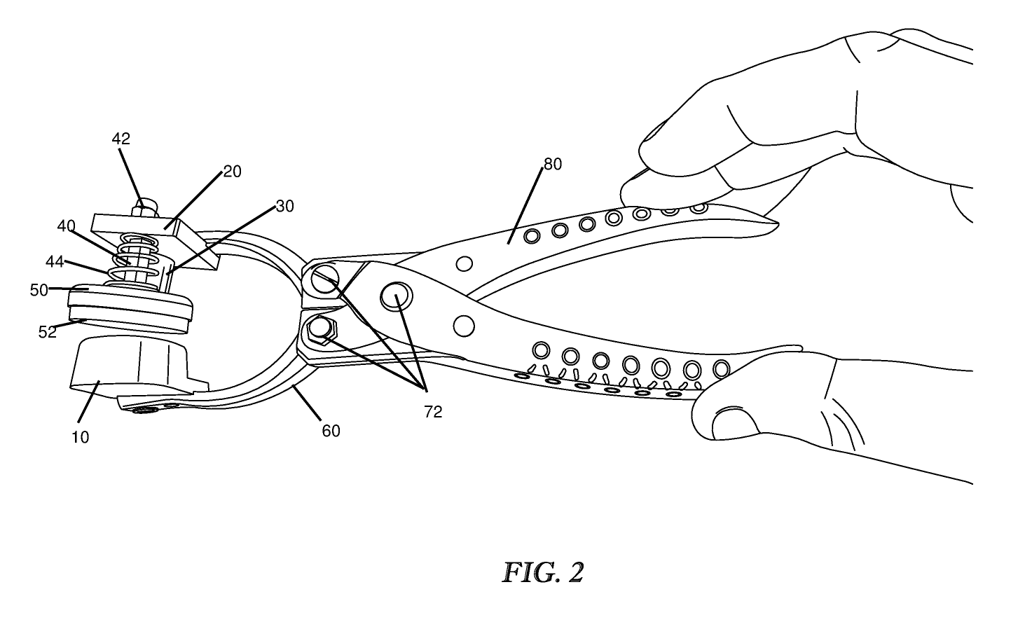

FIG. 2 shows a perspective view of a second tool of embodiments of the disclosed technology. Here, the elements of FIG. 1 are identical except the fulcrum mechanism of the clamping device. A multi-point fulcrum 72 is used with five points (shown by the circles@72) such that the sides of each clamp 60 first move directly towards each other forwards (to the left, as shown in FIG. 2) while being clamped.

FIG. 3 shows a side-elevation view of clamping elements of the disclosed technology. From this view, one can see that the pad 52 of the grasper 50 is lower than the rigid pusher 30. The vertical connector 40 connects the grasper 50 with the upper plate 20 and/or the clamping arm 60. When the clamping arms 60 close towards each other, first the rigid pusher 30 and grasper 50 move in tandem. Eventually, the rigid pusher 50 (or pad 52) cannot move further because it hits the lower support base 10 or an object placed between the grasper 50/52 and the lower support base. Continued closing of the clamping arms 60 towards each other causes the vertical connector 40 to move up through a portal of the upper plate 20 such that an increased length of the upper region 42 extends out from between the upper plate 20 and grasper 50.

FIG. 4 shows a side-elevation view of the clamping elements of FIG. 3 clamping eyeglasses in an embodiment of the disclosed technology. Here, a piece of glass 102 from eyewear, or a side of eyeglasses (as will become more apparent in later figures) is shown between the grasper 50 (or more precisely, the pad 52 of the grasper 50) and the lower support base 10. A bushing 100 is placed on a pedestal 14 connected to the lower support plate 12. Thus, both the lower support base 10 and pedestal 14 are fixedly connected to, or form a unitary structure with the lower support plate 12. In the embodiment shown in FIG. 4, the grasper 50 (pad 52) is pressed against the glass 102, which is, in turn, pressed against the lower support base 10. Thus, the glass 110 is frictionally held in place. The bushing is placed on, and supported by, the pedestal 14. With continued pressure applied against the clamps 80, the clamps 60 move closer together and the bushing 100 will then be pushed into the rigid pusher 30 which descends thereupon. One can place a portal to receive the bushing between the rigid pusher 30 and bushing 100, such that the clamping action (“clamping” being defined as “pressing two objects together”) causes the bushing to pass into or through such a portal. The portal, in embodiments of the disclosed technology, is within an element which is rigidly (designed to remain in a specific shape, size, and position relative to another object) connected to a device which is clamped between the grasper 50 and the lower support base 14. Thus, in embodiments of the disclosed technology, glass 110 is clamped (defined as “held in place due to clamping action”) between the grasper 50 (e.g. pad 52) and lower support base 10 while a bushing 100 is placed on a top side of a pedestal 14. The prongs 102 of the bushing 100 are then pushed into portals of the eyeglass by way of continued clamping action which causes the pedestal 14 to rise towards the rigid pusher 30 or the rigid pusher 30 to lower toward the pedestal 14.

FIG. 5 shows a side-elevation view of clamping elements of FIG. 4 clamping eyeglasses and a bushing holder in the disclosed technology. Here, the bushing prongs 102 are entered into portals of a same size within a device 110 clamped between the pad 52 and support base 10. Thus, the rigid pusher 30 and pedestal 14 are paired together, meaning that they clamp into, or directly toward, each other. Further, the support base 10 and grasper 50 are paired together meaning that they clamp into, or directly towards, each other.

FIG. 6 shows a perspective view of FIG. 4. FIG. 7 shows a perspective view of FIG. 5. In these views, one can see that the outer clamping arms 80 are being clamped together and rotating around the fulcrum point 70, causing the inner clamping arms 60 to clamp together. An object 110, in this case, a piece of glass is being held, or about to be frictionally held, between the grasper 50 and the lower support base 10. Once the object 100 is frictionally held, continued clamping of the inner clamping arms 60 will cause the rigid pusher to continue to move towards the lower support plate 12, while the pusher 50, object/glass 110, and lower support base 10 remain stationary relative to each other.

FIG. 8 is a reverse-perspective view of the clamping elements of the disclosed technology. The pedestal 14 has grooves 16 on a top side thereof. This can be a circular groove, line, or cross of two lines. This holds a bushing or other device which is sized or adapted to have a portion of which is retained by the grooves. a bushing 100 or other connector or elongated flange is placed such that a portion is held within the grooves 16 of the pedestal 14, in embodiments of the disclosed technology, a more elongated section is in parallel with the elongated length of the pedestal 14. As such, the bushing/connector is pointed upward, toward the rigid pusher 30 and can enter directly into (defined as “in parallel, or substantially in parallel, with a direction in which the a piece it is directly correlated with”) the pusher 30.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

1. A clamping device comprising:
an upper plate connected to a grasper and a rigid pusher;
said grasper being connected to a vertical connector which is movable through said upper plate;
said rigid pusher being in a fixed position relative to said upper plate;
a lower plate in a fixed position to a pedestal;
wherein clamping said upper plate and said lower plate together causes said vertical connector to move through said upper plate.

2. The clamping device of claim 1, wherein said grasper extends further from said upper plate than said rigid pusher.

3. The clamping device of claim 2, wherein said pedestal comprises at least one groove on an upper side thereof.

4. The clamping device of claim 3, wherein said at least one groove is adapted to receive a portion of a connector therein, such that a majority of said connector extends out from said at least one groove.

5. The clamping device of claim 4, wherein said grasper comprises a pad at a bottom side of said grasper which is more flexible than said rigid pusher.

6. The clamping device of claim 5, wherein said grasper is spring-loaded such that said spring applies resistive force to said clamping of said upper plate to said lower plate.

7. A kit comprising said clamping device of claim 1 and eyeglasses, wherein said eyeglasses are aligned such that a portal for a connector is situated between said pedestal and said rigid pusher and glass is situated between said rigid pusher and said lower plate.

8. The kit of claim 7, wherein said glass is grasped by said grasper in a first instance while said rigid pusher and said pedestal are spaced apart.

9. The kit of claim 8, wherein in a second instance in time said rigid pusher clamps said eyeglasses to said pedestal.

10. A clamping device comprising:
two clamping arms each actionable to clamp a respective first plate and second plate towards one another;
a grasper connected to said first plate by a vertical connector passing through said first plate;
a spring, extending around said vertical connector and between said first plate and said grasper;
such that compression of said two clamping arms causes said spring to compress and said vertical connector to move through said first plate.

11. The clamping device of claim 10, further comprising a rigid pusher connected to said first plate at a different location than said vertical connector which extends perpendicularly from said rigid pusher.

12. The clamping device of claim 11, wherein said grasper is aligned such that when said two clamping arms are clamped together, said grasper contacts a support base which rises from a plane defined by said second plate.

13. The clamping device of claim 12, wherein said grapser hits said support base before said rigid pusher contacts a pedestal rising from said plane defined by said second plate, when said two clamping arms are clamped together.

14. The clamping device of claim 13, wherein said pedestal has two grooves perpendicular to each other on a side of said pedestal which contacts said rigid pusher when said two clamping arms are clamped together.

15. The clamping device of claim 11, wherein clamping said two clamping arms together first causes said grasper and a device supported by said second plate to come in contact;
further clamping causes said vertical connector to move through said first plate; and
still further clamping causes said rigid pusher to contact a device supported by said second plate.
